(19) United States
(12) Patent Application Publication
(10) Pub. No.: US 2025/0179099 A1
(43) Pub. Date: Jun. 5, 2025

(54) POLYMERIC BROMINATED FLAME RETARDANT, COMPOSITION, AND CABLE WITH SAME

(71) Applicants: Dow Global Technologies LLC, Midland, MI (US); Dow Silicones Corporation, Midland, MI (US)

(72) Inventors: Yabin Sun, Shanghai (CN); Jeffrey M. Cogen, Collegeville, PA (US); Bharat I. Chaudhary, Collegeville, PA (US); Chongsoo Lim, Collegeville, PA (US); Kainan Zhang, Shanghai (CN); Renhua Fan, Shanghai (CN); Xiaohua Li, Shanghai (CN)

(21) Appl. No.: 18/845,078

(22) PCT Filed: Mar. 17, 2022
(86) PCT No.: PCT/CN2022/081478

§ 371 Date: Sep. 9, 2024

(51) Int. Cl. C07F 7/08; C08K 3/22; C08K 5/544; C08L 23/0892

(52) U.S. Cl. CPC C07F 7/0889; C08K 3/2279; C08K 5/5477; C08L 23/0892; C08K 2003/2296; C08L 2201/02; C08L 2203/206

(57) ABSTRACT

The present disclosure provides a tetrabromophthalic anhydride diamine siloxane. In an embodiment, a tetrabromophthalic anhydride diamine siloxane (TDS) is provided with the structure of Formula (1) Formula (1) wherein n is an integer from 1 to 40; and each R is the same or different and each R is independently selected from the group consisting of hydrogen, and a C₁-C₂₀ hydrocarbonyl group. The present disclosure also provides a polymeric composition including the TDS of Formula (1) and a cable including the TDS of Formula (1).

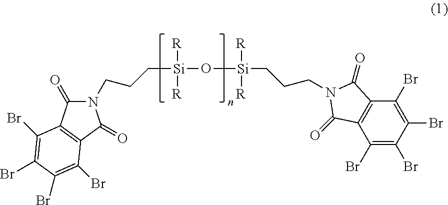

### BACKGROUND

Polymeric compositions containing halogenated flame retardants are known. One category of halogenated flame retardants is the category of brominated flame retardants. Brominated flame retardants are capable of meeting the most stringent burn performance requirements. However, many brominated flame retardants carry the disadvantage of toxicity. Brominated flame retardants such as decabromodiphenyl ethane, decabromodiphenylether, tetrabromobisphenol A bis (2,3-dibromopropyl) ether and ethylene bis-tetrabromophthalimide are known to have high in environmentally persistent, bioaccumulative and toxic (PBT) characteristics.

Interest is increasing in one type of brominated flame retardant, namely polymeric brominated flame retardants, or “PBFRs.” Unlike conventional brominated flame retardants—PBFRs have reduced PBT characteristics, since PBFRs do not readily penetrate biological systems due to their large size. The two main type of PBFRs are brominated styrene-ethylene-butylene-styrene (SEBS) and brominated polystyrene. The brominated SEBS is not thermostable because the Br is connected to the alkyl group of SEBS. There will be premature dissociation of C—Br bond. In brominated polystyrene, the Br is connected to an aromatic ring which is stable in compounding and processing. However, the flame retardant performance for brominated SEBS in polyolefin-based systems is not good due to poor compatibility with polyolefins.

The art recognizes the need for polymeric brominated flame retardants capable of meeting the most stringent burn performance requirements, while also exhibiting low potential of bioaccumulation and toxicity characteristics and suitable thermal stability to withstand melt blending and/or extrusion with polyolefins.

### SUMMARY

The present disclosure provides a tetrabromophthalic anhydride diamine siloxane. In an embodiment, a tetrabromophthalic anhydride diamine siloxane (TDS) is provided with the structure of Formula (1)

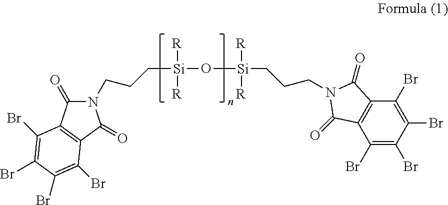

wherein n is an integer from 1 to 40; and
each R is the same or different and each R is independently selected from the group consisting of hydrogen, and a C₁-C₂₀ hydrocarbonyl group.

The present disclosure provides a polymeric composition. In an embodiment, a polymeric composition is provided and includes a flame retardant that is a tetrabromophthalic anhydride diamine siloxane (TDS) with the structure of Formula (1)

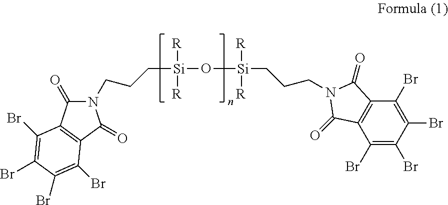

wherein n is an integer from 1 to 40; and
each R is the same or different and each R is independently selected from the group consisting of hydrogen, and a C₁-C₂₀ hydrocarbonyl group, In a further embodiment, the polymeric composition includes a silane-functionalized polyolefin.

The present composition includes an article. In an embodiment, In an embodiment, the article is a cable and includes a conductor and a coating on the conductor. The coating includes a silane-functionalized polyolefin; and a flame retardant. The flame retardant is a tetrabromophthalic anhydride diamine siloxane (TDS) with the structure of Formula (1)

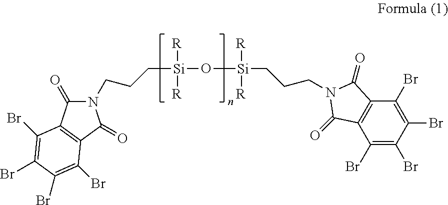

wherein n is an integer from 1 to 40; and
each R is the same or different and each R is independently selected from the group consisting of hydrogen, and a C₁-C₂₀ hydrocarbonyl group.

The present inventors functionalized tetrabromophthalic anhydride with amino functionalized siloxane to produce a thermally stable aromatic bromide based on phthalimide siloxane structure. The brominated phthalimide structure provides a stable aromatic bromide during processing and an effective bromide release that exhibits excellent flame retardant performance. The siloxane units provide suitable molecular weight to reduce bio-penetration, reduce PBT concerns of bioaccumulation and toxicity characteristics, and increase char formation. Additionally, the incorporated siloxane units improve compatibilization of the components with different polarities by their flexibility and low surface energy characteristics. As a result, the present tetrabromophthalic anhydride diamine siloxane is readily dispersible in polymer matrix compared to other polymeric brominated flame retardants. The present tetrabromophthalic anhydride diamine siloxane exhibits good flame retardancy in polyolefin-based systems.

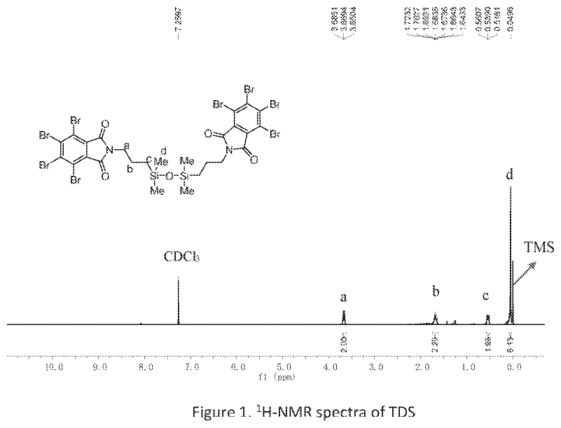

FIG. 1 is a ¹H-NMR spectrograph of a tetrabromophthalic anhydride diamine siloxane (TDS), in accordance with an embodiment of the present disclosure.

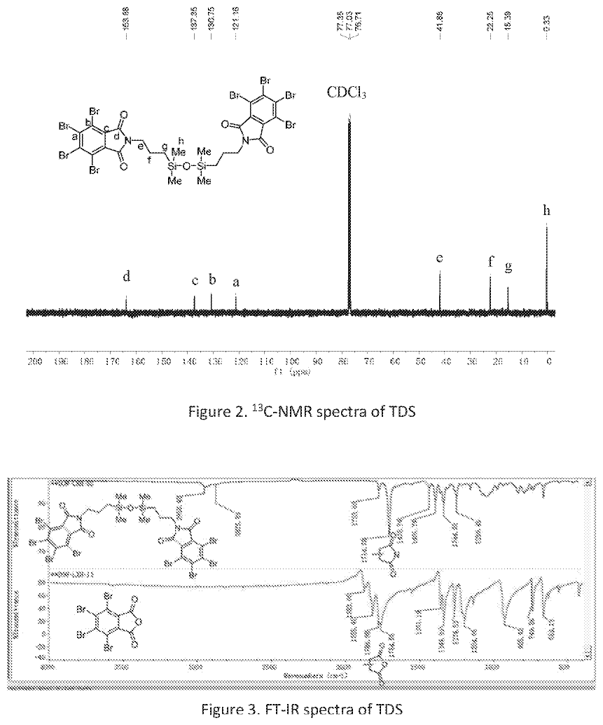

FIG. 2 is a ¹³C-NMR spectrograph of the TDS of FIG. 1, in accordance with an embodiment of the present disclosure.

FIG. 3 is an FT-IR spectrograph of the TDS of FIG. 1, in accordance with an embodiment of the present disclosure.

### DEFINITIONS

Any reference to the Periodic Table of Elements is that as published by CRC Press, Inc., 1990-1991. Reference to a group of elements in this table is by the new notation for numbering groups.

For purposes of United States patent practice, the contents of any referenced patent, patent application or publication are incorporated by reference in their entirety (or its equivalent U.S. version is so incorporated by reference) especially with respect to the disclosure of definitions (to the extent not inconsistent with any definitions specifically provided in this disclosure).

The numerical ranges disclosed herein include all values from, and including, the lower and upper value. For ranges containing explicit values (e.g., from 1 or 2, or 3 to 5, or 6, or 7), any subrange between any two explicit values is included (e.g., the range 1-7 above includes subranges of from 1 to 2; from 2 to 6; from 5 to 7; from 3 to 7; from 5 to 6; etc.).

Unless stated to the contrary, implicit from the context, or customary in the art, all parts and percents are based on weight and all test methods are current as of the filing date of this disclosure.

An “alkyl group” is a saturated linear, cyclic, or branched hydrocarbonyl group. Nonlimiting examples of suitable alkyl groups include methyl, ethyl, n-propyl, i-propyl, n-butyl, t-butyl, i-butyl (or 2-methylpropyl), etc.

An “aminoalkyl group” is an alkyl group containing one or more amino groups.

An “amino group,” is a nitrogen atom attached by a single bond to a hydrogen atom and/or to a hydrocarbon.

The terms “blend” or “polymer blend,” as used, refers to a mixture of two or more polymers. A blend may or may not be miscible (not phase separated at molecular level). A blend may or may not be phase separated. A blend may or may not contain one or more domain configurations, as determined from transmission electron spectroscopy, light scattering, x-ray scattering, and other methods known in the art. The blend may be effected by physically mixing the two or more polymers on the macro level (for example, melt blending resins or compounding), or the micro level (for example, simultaneous forming within the same reactor).

The term “composition” refers to a mixture of materials which comprise the composition, as well as reaction products and decomposition products formed from the materials of the composition.

The terms “comprising,” “including,” “having” and their derivatives, are not intended to exclude the presence of any additional component, step or procedure, whether or not the same is specifically disclosed. In order to avoid any doubt, all compositions claimed through use of the term “comprising” may include any additional additive, adjuvant, or compound, whether polymeric or otherwise, unless stated to the contrary. In contrast, the term “consisting essentially of” excludes from the scope of any succeeding recitation any other component, step, or procedure, excepting those that are not essential to operability. The term “consisting of” excludes any component, step, or procedure not specifically delineated or listed. The term “or,” unless stated otherwise, refers to the listed members individually as well as in any combination.

An “ethylene-based polymer” is a polymer that contains more than 50 weight percent (wt %) polymerized ethylene monomer (based on the total amount of polymerizable monomers) and, optionally, may contain at least one comonomer. Ethylene-based polymer includes ethylene homopolymer, and ethylene copolymer (meaning units derived from ethylene and one or more comonomers). The terms “ethylene-based polymer” and “polyethylene” may be used interchangeably. Ethylene-based polymer may include ethylene copolymerized with an α-olefin (i.e., C₃-C₁₂ α-olefin, or C₄-C₈ α-olefin) and/or unsaturated ester.

The term “ethylene monomer,” or “ethylene,” as used herein, refers to a chemical unit having two carbon atoms with a double bond there between, and each carbon bonded to two hydrogen atoms, wherein the chemical unit polymerizes with other such chemical units to form an ethylene-based polymer composition.

A “heteroatom” is an atom other than carbon or hydrogen. The heteroatom can be a non-carbon atom from Groups IV, V, VI and VII of the Periodic Table. Nonlimiting examples of heteroatoms include: F, N, O, P, B, S, and Si.

A “hydrocarbon” is a compound containing only hydrogen atoms and carbon atoms. A “hydrocarbonyl” (or “hydrocarbonyl group”) is a hydrocarbon having a valence (typically univalent). A hydrocarbon can have a linear structure, a cyclic structure, or a branched structure.

“Linear low density polyethylene” (or “LLDPE”) is a linear ethylene/α-olefin copolymer containing heterogeneous short-chain branching distribution comprising units derived from ethylene and units derived from at least one C₃-C₁₀ α-olefin comonomer or at least one C₄-C₈ α-olefin comonomer, or at least one C₆-C₈ α-olefin comonomer. LLDPE is characterized by little, if any, long chain branching, in contrast to conventional LDPE. LLDPE has a density from 0.910 g/cc, or 0.915 g/cc, or 0.920 g/cc, or 0.925 g/cc to 0.930 g/cc, or 0.935 g/cc, or 0.940 g/cc. Nonlimiting examples of LLDPE include TUFLIN™ linear low density polyethylene resins and DOWLEX™ polyethylene resins, each available from the Dow Chemical Company; and MARLEX™ polyethylene (available from Chevron Phillips).

“Low density polyethylene” (or “LDPE”) consists of ethylene homopolymer, or ethylene copolymer with acrylate, vinyl acetate, and/or vinyl silane as comonomer, the LDPE has a density from 0.915 g/cc to 0.940 g/cc and contains long chain branching with broad MWD. LDPE is typically produced by way of high pressure free radical polymerization (tubular reactor or autoclave with free radical initiator). Nonlimiting examples of LDPE include MarFlex™ (Chevron Phillips), LUPOLEN™ (LyondellBasell), as well as LDPE products from Borealis, Ineos, ExxonMobil, and others.

“Medium density polyethylene” (or “MDPE”) is an ethylene homopolymer, or an ethylene/α-olefin copolymer comprising at least one C₃-C₁₀ α-olefin, or a C₃-C₄ α-olefin, that has a density from 0.926 g/cc to 0.940 g/cc.

An “olefin” is an unsaturated, aliphatic hydrocarbon having a carbon-carbon double bond.

An “olefin-based polymer” (interchangeably referred to as “polyolefin”) is a polymer that contains a majority weight percent of polymerized olefin monomer (based on the total amount of polymerizable monomers), and optionally, may contain at least one comonomer. Nonlimiting examples of olefin-based polymer include ethylene-based polymer and propylene-based polymer.

The term “polymer” or a “polymeric material,” as used herein, refers to a compound prepared by polymerizing monomers, whether of the same or a different type, that in polymerized form provide the multiple and/or repeating “units” or “mer units” that make up a polymer. The generic term polymer thus embraces the term homopolymer, usually employed to refer to polymers prepared from only one type of monomer, and the term copolymer, usually employed to refer to polymers prepared from at least two types of monomers. It also embraces all forms of copolymer, e.g., random, block, etc. The terms “ethylene/α-olefin polymer” and “propylene/α-olefin polymer” are indicative of copolymer as described above prepared from polymerizing ethylene or propylene respectively and one or more additional, polymerizable α-olefin monomer. It is noted that although a polymer is often referred to as being “made of” one or more specified monomers, “based on” a specified monomer or monomer type, “containing” a specified monomer content, or the like, in this context the term “monomer” is understood to be referring to the polymerized remnant of the specified monomer and not to the unpolymerized species. In general, polymers herein are referred to as being based on “units” that are the polymerized form of a corresponding monomer.

A “propylene-based polymer” is a polymer that contains more than 50 weight percent polymerized propylene monomer (based on the total amount of polymerizable monomers) and, optionally, may contain at least one comonomer. Propylene-based polymer includes propylene homopolymer, and propylene copolymer (meaning units derived from propylene and one or more comonomers). The terms “propylene-based polymer” and “polypropylene” may be used interchangeably. A nonlimiting example of a propylene-based polymer (polypropylene) is a propylene/α-olefin copolymer with at least one C₂ or C₄-C₁₀ α-olefin comonomer.

A “sheath” refers to a cable covering and includes insulation coverings or layers, protective jackets and the like.

A “silane,” as used herein, is a compound with one or more Si—C bonds.

A “siloxane,” as used herein, is a compounding with one or more Si—O—Si bonds.

### Test Methods

### Burn Tests

The vertical burn test was conducted in a UL94 (Underwriter's Laboratories 94) chamber on 2 mm thick specimen according to UL94 specification as provided below.
Before the test begins, plastic samples are placed vertically in the burn chamber. Each sample is 127 mm×12.7 mm in dimension, with 2 mm thickness.
Once the sample has been mounted, a carefully controlled flame is placed under the specimen for 10 seconds and then removed. When the flame is no longer in contact with the specimen, any residual flaming combustion of the plastic sample is observed and recorded.
When the plastic sample finally self-extinguishes, the controlled flame is immediately reapplied for another 10 seconds, and then removed. Again, the specimen's flaming combustion (in the absence of flame exposure) is recorded.
A piece of dry surgical cotton is located 12 inches below the combusting sample. If any drips fall onto the cotton and cause it to ignite, this detail is also recorded.

Density is measured in accordance with ASTM D792, Method B. Results are reported in grams per cubic centimeter (g/cc).

### Melt Index

The term “melt index,” or “MI” as used herein, refers to the measure of how easily a thermoplastic polymer flows when in a melted state. Melt index, or I₂, is measured in accordance by ASTM D 1238, Condition 190° C./2.16 kg, and is reported in grams eluted per 10 minutes (g/10 min). The I10 is measured in accordance with ASTM D 1238, Condition 190° C./10 kg, and is reported in grams eluted per 10 minutes (g/10 min).

### Nuclear Magnetic Resonance (NMR)

¹H-NMR was used to characterize the molecule structure with a Bruker NMR spectrometer (400 MHz). 20 mg of sample was dissolved into 0.5 ml CDCl₃ for the ¹H-NMR test.

¹³C-NMR was used to characterize the molecule structure with Bruker NMR spectrometer (100 MHz). 20 mg of sample was dissolved into 0.5 ml CDCl₃ for the ¹³C-NMR test.

Thermogravimetric Analysis (TGA). Thermogravimetric Analysis was performed using a Q5000 thermogravimetric analyzer from TA INSTRUMENTS™. Thermogravimetric Analysis was performed by placing a sample of the material in the thermogravimetric analyzer on platinum pans under nitrogen at flow rate of 25 cm³/minute and, after equilibrating at 40° C., raising the temperature from 40° C. to 650° C. at a rate of 20° C./minute and switch air and heating from 650° C. to 800° C. at the rate of 20° C./minute. The percent mass retained at 650° C. was a measure of the residue obtained in the form of char, and this value was recorded. That is, this TGA method characterizes the char formation of the flame retardant. Higher residue indicates better char formation.

### DETAILED DESCRIPTION

### 1. Tetrabromophthalic Anhydride Diamine Siloxane

In an embodiment, the present disclosure is directed to a tetrabromophthalic anhydride diamine siloxane (TDS). The TDS has the structure of Formula (1) below

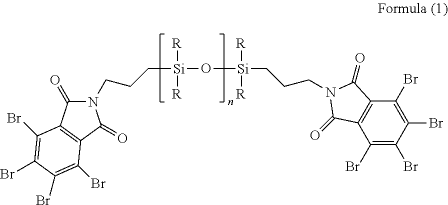

wherein n is an integer from 1 to 40, or from 2 to 30, or from 3 to 20, or from 4 to 15; and each R is the same or different and each R is independently selected from the group consisting of hydrogen, and a C₁-C₂₀ hydrocarbonyl group.

In an embodiment, the preparation of the TDS is performed by reacting tetrabromophthalic anhydride (TBPA) with an alkylaminoalkyldisiloxane, such as 1,3-Bis(3-aminopropyl)-1,1,3,3-tetramethyldisiloxane (BAPTMDS), for example, in solvent, such as tetrahydrofuran, under reflux for two hours to six hours, or four hours. The disiloxane moiety in the alkylaminoalkyldisiloxane promotes the formation of a TDS that is linear in structure. The reaction involves imidization between the amine groups of the alkylaminoalkyldisiloxane and the anhydride in the TBPA and connects two TBPA units by way of the alkylaminoalkyldisiloxane.

In an embodiment, the TDS with the structure of Formula (1) has a molecular weight from 1,000 g/mol to 5,000 g/mol, or from 1,500 g/mol to 4,000 g/mol, or from 2,000 g/mol to 3,000 g/mol. In a further embodiment, n=20 and the TDS with the structure of Formula (1) has a molecular weight of 2640 g/mol.

In an embodiment, the TDS has the structure of Formula (2)

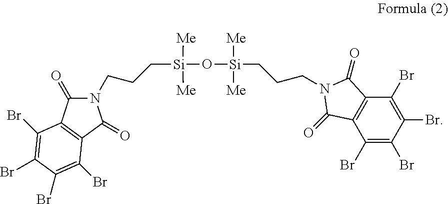 [SMILES: C[Si](C)(CCCN1C(=O)c2c(Br)c(Br)c(Br)c(Br)c2C1=O)O[Si](C)(C)CCCN1C(=O)c2c(Br)c(Br)c(Br)c(Br)c2C1=O]

### 2. Polymeric Composition

The present disclosure provides a polymeric composition. The polymeric composition includes the TDS with the structure of Formula (1). In an embodiment, the polymeric composition Includes a polyolefin (such as silane-functionalized polyolefin, for example) and the TDS with the structure of Formula (1)

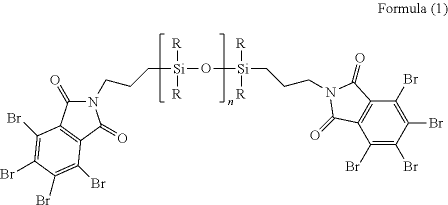

wherein n is an integer from 1 to 40, or from 2 to 30, or from 3 to 20, or from 4 to 15; and each R is the same or different and each R is independently selected from the group consisting of hydrogen, and a C₁-C₂₀ hydrocarbonyl group.

In an embodiment, the polymeric composition includes a silane functionalized polyolefin. A “silane-functionalized polyolefin,” as used herein, is a polymer that contains silane and greater than 50 wt %, or a majority amount, of polymerized ethylene-based on the total weight of the silane-functionalized polyolefin.

In an embodiment, the silane-functionalized polyolefin is a silane-functionalized ethylene-based polymer. A “silane functionalized ethylene-based polymer” is a polymer that contains silane and greater than 50 wt %, or a majority amount, of polymerized ethylene, based on the total weight of the polymer. Nonlimiting examples of suitable silane functionalized polyolefin include ethylene/silane copolymer, silane-grafted polyethylene (Si-g-PE), and combinations thereof.

An “ethylene/silane copolymer” is formed by the copolymerization of ethylene and a hydrolysable silane monomer (such as a vinyl-alkoxysilane monomer). In an embodiment, the ethylene/silane copolymer is prepared by the copolymerization of ethylene, a hydrolysable silane monomer and, optionally, an unsaturated ester. The preparation of ethylene/silane copolymers is described, for example, in U.S. Pat. Nos. 3,225,018 and 4,574,133, each incorporated herein by reference.

A “silane-grafted polyethylene” (or “Si-g-PE”) is formed by grafting a hydrolysable silane monomer (such as a vinyl alkoxysilane monomer) onto the backbone of a base polyethylene. In an embodiment, grafting takes place in the presence of a free-radical generator, such as a peroxide. The hydrolysable silane monomer can be grafted to the backbone of the base polyethylene (i) prior to incorporating or compounding the Si-g-PE into a composition used to make a final article, such as a coated conductor (also known as a SIOPLAS™ process), or (ii) simultaneously with the extrusion of a composition to form a final article (also known as a MONOSIL™ process, in which the Si-g-PE is formed in situ during melt blending and extrusion). In an embodiment, the Si-g-PE is formed before the Si-g-PE is compounded with inorganic hollow microspheres, and other optional components. In another embodiment, the Si-g-PE is formed in situ by compounding a polyethylene, hydrolysable silane monomer, and peroxide initiator, along with inorganic hollow microspheres, and other optional components,

The base polyethylene for the Si-g-PE may be any ethylene-based polymer disclosed herein. Non-limiting examples of suitable ethylene-based polymers include ethylene homopolymers and ethylene-based interpolymers containing one or more polymerizable comonomers, such as an unsaturated ester and/or an α-olefin. In an embodiment, the ethylene-based polymer is selected from a low-density polyethylene (LDPE), a high-density polyethylene (HDPE), and combination thereof.

The hydrolysable silane monomer is a silane-containing monomer that will effectively copolymerize with an α-olefin (e.g., ethylene) to form an α-olefin/silane copolymer (such as an ethylene/silane copolymer), or graft to an α-olefin polymer (i.e., a polyolefin) to form a Si-g-polyolefin, thus enabling subsequent crosslinking of the silane-functionalized polyolefin. A representative, but not limiting, example of a hydrolyzable silane monomer has structure (I):

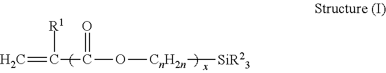

in which R¹ is a hydrogen atom or methyl group; x is 0 or 1; n is an integer from 1 to 4, or 6, or 8, or 10, or 12; and each R² independently is a hydrolyzable organic group such as an alkoxy group having from 1 to 12 carbon atoms (e.g., methoxy, ethoxy, butoxy), an aryloxy group (e.g., phenoxy), an araloxy group (e.g., benzyloxy), an aliphatic acyloxy group having from 1 to 12 carbon atoms (e.g., formyloxy, acetyloxy, propanoyloxy), an amino or substituted amino group (e.g., alkylamino, arylamino), or a lower-alkyl group having 1 to 6 carbon atoms, with the proviso that not more than one of the three R² groups is an alkyl. The hydrolyzable silane monomer may be copolymerized with an α-olefin (such as ethylene) in a reactor, such as a high-pressure process, to form an α-olefin/silane copolymer. In examples where the α-olefin is ethylene, such a copolymer is referred to herein as an ethylene/silane copolymer. The hydrolyzable silane monomer may also be grafted to a polyolefin (such as a polyethylene) by the use of an organic peroxide, such as 2,5-bis(tert-butylperoxy)-2,5-dimethylhexane, to form a Si-g-PO or an in-situ Si-g-PO. The in-situ Si-g-PO is formed by a process such as the MONOSIL process, in which a hydrolyzable silane monomer is grafted onto the backbone of a polyolefin during the extrusion of the present composition to form a coated conductor, as described, for example, in U.S. Pat. No. 4,574,133.

The hydrolyzable silane monomer may include silane monomers that comprise an ethylenically unsaturated hydrocarbyl group, such as a vinyl, allyl, isopropenyl, butenyl, cyclohexenyl or gamma (meth)acryloxy allyl group, and a hydrolyzable group, such as, for example, a hydrocarbyloxy, hydrocarbonyloxy, or hydrocarbylamino group. Hydrolyzable groups may include methoxy, ethoxy, formyloxy, acetoxy, proprionyloxy, and alkyl or arylamino groups. In a specific example, the hydrolyzable silane monomer is an unsaturated alkoxy silane, which can be grafted onto the polyolefin or copolymerized in-reactor with an α-olefin (such as ethylene). Examples of hydrolyzable silane monomers include vinyltrimethoxysilane (VTMS), vinyltriethoxysilane (VTES), vinyltriacetoxysilane, and gamma-(meth)acryloxy propyl trimethoxy silane. In context to Structure (I), for VTMS: x=0; R¹=hydrogen; and R²=methoxy; for VTES: x=0; R¹=hydrogen; and R²=ethoxy; and for vinyltriacetoxysilane: x=0; R¹=H; and R²=acetoxy.

Examples of suitable ethylene/silane copolymers are commercially available as SI-LINK™ DFDA-5451 NT and SI-LINK™ AC DFDB-5451 NT, each available from The Dow Chemical Company, Midland, MI. Examples of suitable Si-g-PO are commercially available as PEXIDAN™ A-3001 from SACO AEI Polymers, Sheboygan, WI and SYNCURE™ S1054A from PolyOne, Avon Lake, OH.

In an embodiment, the silane functionalized ethylene-based polymer contains from 0.1 wt %, or 0.3 wt %, or 0.5 wt %, or 0.8 wt %, or 1.0 wt %, or 1.2 wt %, or 1.5 wt %, or 1.6 wt % to 1.8 wt %, or 2.0 wt %, or 2.3 wt %, or 2.5 wt %, or 3.0 wt %, or 3.5 wt %, or 4.0 wt %, or 4.5 wt %, or 5.0 wt % silane, based on the total weight of the silane functionalized ethylene-based polymer.

In an embodiment, the silane functionalized ethylene-based polymer contains (i) from 50 wt %, or 55 wt %, or 60 wt %, or 65 wt %, or 70 wt %, or 80 wt %, or 90 wt %, or 95 wt % to 97 wt %, or 98 wt %, or 99 wt %, or less than 100 wt % ethylene and (il) from 0.1 wt %, or 0.3 wt % or 0.5 wt %, or 0.8 wt %, or 1.0 wt %, or 1.2 wt %, or 1.5 wt %, or 1.6 wt % to 1.8 wt %, or 2.0 wt %, or 2.3 wt %, or 2.5 wt %, or 3.0 wt %, or 3.5 wt %, or 4.0 wt %, or 4.5 wt %, or 5.0 wt % silane, based on the total weight of the silane functionalized polyethylene.

In an embodiment, the silane functionalized ethylene-based polymer has a density from 0.850 g/cc, or 0.860 g/cc, or 0.875 g/cc, or 0.890 g/cc, or 0.900 g/cc, or 0.910 g/cc, or 0.915 g/cc, or 0.920 g/cc to 0.925 g/cc, or 0.930 g/cc, or 0.940 g/cc, or 0.950 g/cc or 0.960 g/cc, or 0.965 g/cc. In another embodiment, the silane functionalized ethylene-based polymer has a density from 0.850g/cc to 0.965 g/cc, or from 0.900 g/cc to 0.950 g/cc, or from 0.920 g/cc to 0.925 g/cc.

In an embodiment, the silane functionalized ethylene-based polymer has a melt index (MI) from 0.1 g/10 min, or 0.5 g/10 min, or 1.0 g/10 min, or 1.5 g/10 min to 6 g/10 min, or 10 g/10 min, or 15 g/10 min, or 20 g/10 min, or 30 g/10 min, or 40 g/10 min, or 50 g/10 min. In another embodiment, the functionalized ethylene-based polymer has a melt index (MI) from 0.1 g/10 min to 50 g/10 min, or from 0.5 g/10 min to 10 g/10 min.

In an embodiment, the silane functionalized ethylene-based polymer is an ethylene/silane copolymer. The ethylene/silane copolymer contains ethylene and the hydrolyzable silane monomer as the only monomeric units. In another embodiment, the ethylene/silane copolymer optionally includes a C₃, or C₄ to C₆, or C₈, or C₁₀, or C₁₂, or C₁₆, or C₁₈, or C₂₀ α-olefin; an unsaturated ester; and combinations thereof. In an embodiment, the ethylene/silane copolymer is an ethylene/unsaturated ester/silane reactor copolymer. Non-limiting examples of suitable ethylene/silane copolymers include SI-LINK™ DFDA-5451 NT and SI-LINK™ AC DFDB-5451 NT, each available from The Dow Chemical Company.

The ethylene/silane copolymer may comprise two or more embodiments disclosed herein.

In an embodiment, the silane functionalized ethylene-based polymer is a Si-g-PE.

The base ethylene-based polymer for the Si-g-PE includes from 50 wt %, or 55 wt %, or 60 wt %, or 65 wt %, or 70 wt %, or 80 wt %, or 90 wt %, or 95 wt % to 97 wt %, or 98 wt %, or 99 wt %, or 100 wt % ethylene, based on the total weight of the base ethylene-based polymer.

In an embodiment, the base ethylene-based polymer for the Si-g-PE has a density from 0.850 g/cc, or 0.860 g/cc, or 0.875 g/cc, or 0.890 g/cc, or 0.900 g/cc, or 0.910 g/cc, or 0.915 g/cc, or 0.920 g/cc to 0.925 g/cc, or 0.930 g/cc, or 0.940 g/cc, or 0.950 g/cc or 0.960 g/cc, or 0.965 g/cc. In another embodiment, the base ethylene-based polymer for the Si-g-PE has a density from 0.850 g/cc to 0.965 g/cc, or from 0.900 g/cc to 0.950 g/cc, or from 0.920 g/cc to 0.925 g/cc.

In an embodiment, the base ethylene-based polymer for the Si-g-PE has a melt index (MI) from 0.1 g/10 min, or 0.5 g/10 min, or 1.0 g/10 min, or 1.5 g/10 min to 6 g/10 min, or 10 g/10 min, or 15 g/10 min, or 20 g/10 min, or 30 g/10 min, or 40 g/10 min, or 50 g/10 min. In another embodiment, base ethylene-based polymer for the Si-g-PE has a melt index (MI) from 0.1 g/10 min to 50 g/10 min, or from 0.5 g/10 min to 10 g/10 min.

In an embodiment, the base ethylene-based polymer for the Si-g-PE is an ethylene/α-olefin copolymer. The α-olefin contains from 3, or 4 to 6, or 8, or 10, or 12, or 16, or 18, or 20 carbon atoms. Non-limiting examples of suitable-olefin include propylene, butene, hexene, and octene. In an embodiment, the ethylene-based copolymer is an ethylene/octene copolymer. When the ethylene-based copolymer is an ethylene/α-olefin copolymer, the Si-g-PE is a silane-grafted ethylene/α-olefin copolymer. Non-limiting examples of suitable ethylene/α-olefin copolymers useful as the base ethylene-based polymer for the Si-g-PE include the ENGAGE™ and INFUSE™ resins available from the Dow Chemical Company.

In an embodiment, the base ethylene-based polymer for the Si-g-PE is a low-density polyethylene (LDPE). LDPE has a density from 0.915 g/cc to 0.940 g/cc and contains long chain branching with broad MWD. In an embodiment, the LDPE has a density from 0.915 g/cc, or 0.920 g/cc to 0.925 g/cc, or 0.930 g/cc, or 0.940 g/cc,

In an embodiment, the Si-g-PE is a silane-grafted ethylene/C₄-C₈ α-olefin copolymer. The silane-grafted ethylene/C₄-C₈ α-olefin copolymer consists of the hydrolyzable silane monomer, ethylene, and C₄-C₈ α-olefin comonomer. In other words, the silane-grafted ethylene/C₄-C₈ α-olefin copolymer contains the hydrolyzable silane monomer, ethylene, and C₄-C₈ α-olefin comonomer as the only monomeric units.

In an embodiment, the Si-g-PE is a silane-grafted LDPE (“Si-g-LDPE”). The Si-g-LDPE has one, some, or all of the following properties: (i) a density from 0.915 g/cc to 0.940 g/cc, or from 0.920 g/cc to 0.930 g/cc; and/or (ii) a melt index from 0.1 g/10 min to 50 g/10 min, or from 0.5 g/10 min to 10 g/10 min; and/or (iii) a silane content from 0.1 wt % to 5 wt %, or from 0.5 wt % to 3.0 wt %, based on the total weight of the Si-g-LDPE. In a further embodiment, the Si-g-LDPE consists of the hydrolyzable silane monomer, ethylene, and C₄-C₈ α-olefin comonomer.

The Si-g-PE may comprise two or more embodiments disclosed herein.

Blends of silane functionalized ethylene-based polymers may also be used, and the silane-functionalized ethylene-based polymer(s) may be diluted with one or more other polyolefins to the extent that the polyolefins are (i) miscible or compatible with one another, and (ii) the silane functionalized ethylene-based polymer(s) constitutes from 50 wt %, or 55 wt %, or 60 wt %, or 65 wt %, or 70 wt %, or 75 wt %, or 80 wt %, or 85 wt %, or 90 wt %, or 95 wt %, or 98 wt %, or 99 wt % to less than 100 wt % of the blend (based on the combined weight of the polyolefins, including the silane functionalized ethylene-based polymer).

The silane functionalized ethylene-based polymer may comprise two or more embodiments disclosed herein.

The polymeric composition includes the TDS with the structure of Formula (1) or the TDS with the structure of Formula (2) in addition to the silane-functionalized polyolefin. The TDS is a flame retardant for the polymeric composition. The polymeric composition includes from 50 wt % to 95 wt % silane-functionalized polyolefin and from 50 wt % to 5 wt % TDS, or from 60 wt % to 90 wt % silane-functionalized polyolefin and from 40 wt % to 10 wt % TDS, the silane-functionalized polyolefin and the TDS amounting to 100 wt % of the polymeric composition.

In an embodiment, the polymeric composition includes a silane-functionalized polyolefin that is an ethylene/silane copolymer, the TDS with the structure of Formula (1), a flame retardant synergist, and an optional second polyolefin. A “flame retardant synergist,” as used herein, is a compound that increases the flame retardancy properties of the TDS. Nonlimiting examples of suitable flame retardant synergist include antimony trioxide (Sb₂O₃), zinc borate, zinc carbonate, zinc carbonate hydroxide, hydrated zinc borate, zinc phosphate, zinc stannate, zinc hydrostannate, zinc sulfide, zinc oxide and combinations thereof.

The second polyolefin (when present) can be an ethylene-based polymer, or a propylene-based polymer. In an embodiment, the second polyolefin is an ethylene-based polymer that is an ethylene/C₃-C₈ α-olefin copolymer, or an ethylene/C₄-C₈ α-olefin copolymer. Non-limiting examples of suitable α-olefin include propylene, butene, hexene, and octene. In an embodiment, the ethylene-based copolymer is an ethylene/octene copolymer. Non-limiting examples of suitable ethylene/octene copolymers include DOWLEX™ resins, and/or ENGAGE™ resins available from the Dow Chemical Company.

### 3. Additive

The polymeric composition may include one or more optional additives. Nonlimiting examples of suitable additives include antioxidants, colorants, corrosion inhibitors, lubricants, moisture cure catalysts, ultraviolet (UV) absorbers or stabilizers, anti-blocking agents, coupling agents, compatibilizers, plasticizers, fillers, processing aids, and combinations thereof.

In an embodiment, the polymeric composition includes an antioxidant. Nonlimiting examples of suitable antioxidants include phenolic antioxidants, thio-based antioxidants, phosphate-based antioxidants, and hydrazine-based metal deactivators. Suitable phenolic antioxidants include high molecular weight hindered phenols, methyl-substituted phenol, phenols having substituents with primary or secondary carbonyls, and multifunctional phenols such as sulfur and phosphorous-containing phenol. Representative hindered phenols include 1,3,5-trimethyl-2,4,6-tris-(3,5-di-tert-butyl-4-hydroxybenzyl)-benzene; pentaerythrityl tetrakis-3(3,5-di-tert-butyl-4-hydroxyphenyl)-propionate; n-octadecyl-3(3,5-di-tert-butyl-4-hydroxyphenyl)-propionate; 4,4′-methylenebis(2,6-tert-butyl-phenol); 4,4′-thiobis(6-tert-butyl-o-cresol); 2,6-di-tertbutylphenol; 6-(4-hydroxyphenoxy)-2,4-bis(n-octyl-thio)-1,3,5 triazine; di-n-octylthio)ethyl 3,5-di-tert-butyl-4-hydroxy-benzoate; and sorbitol hexa[3-(3,5-di-tert-butyl-4-hydroxy-phenyl)-propionate]. In an embodiment, the polymeric composition includes pentaerythritol tetrakis(3-(3,5-di-tert-butyl-4-hydroxyphenyl)propionate), commercially available as Irganox™ 1010 from BASF. A nonlimiting example of a suitable methyl-substituted phenol is isobutylidenebis(4,6-dimethylphenol). A nonlimiting example of a suitable hydrazine-based metal deactivator is oxalyl bis (benzylidiene hydrazide). In an embodiment, the polymeric composition contains 0 or wt %, from 0.001 wt %, or 0.01 wt %, or 0.02 wt %, or 0.05 wt %, or 0.1 wt %, or 0.2 wt %, or 0.3 wt %, or 0.4 wt % to 0.5 wt %, or 0.6 wt %, or 0.7 wt %, or 0.8 wt %, or 1.0 wt %, or 2.0 wt %, or 2.5 wt %, or 3.0 wt % antioxidant, based on total weight of the polymeric composition.

In an embodiment, the polymeric composition includes a moisture cure catalyst, such as a Lewis and Brønsted acid and/or a Lewis and Brønsted base. A “moisture cure catalyst,” as used herein, is a compound that promotes crosslinking of the silane functionalized polyolefin through hydrolysis and condensation reactions. Lewis acids are chemical species that can accept an electron pair from a Lewis base. Lewis bases are chemical species that can donate an electron pair to a Lewis acid. Nonlimiting examples of suitable Lewis acids include the tin carboxylates such as dibutyl tin dilaurate (DBTDL), dimethyl hydroxy tin oleate, dioctyl tin maleate, di-n-butyl tin maleate, dibutyl tin diacetate, dibutyl tin dioctoate, stannous acetate, stannous octoate, and various other organo-metal compounds such as lead naphthenate, zinc caprylate and cobalt naphthenate. Nonlimiting examples of suitable Lewis bases include the primary, secondary and tertiary amines. Nonlimiting examples of suitable Brønsted acids are methanesulfonic acid, benzenesulfonic acid, dodecylbenzenesulfonic acid, naphthalenesulfonic acid, or an alkylnaphthalenesulfonic acid. The moisture cure catalyst may comprise a blocked sulfonic acid. The blocked sulfonic acid may be as defined in US 2016/0251535 A1 and may be a compound that generates in-situ a sulfonic acid upon heating thereof, optionally in the presence of moisture or an alcohol. Examples of blocked sulfonic acids include amine-sulfonic acid salts and sulfonic acid alkyl esters. The blocked sulfonic acid may consist of carbon atoms, hydrogen atoms, one sulfur atom, and three oxygen atoms, and optionally a nitrogen atom. These catalysts are typically used in moisture cure applications. The polymeric composition includes 0 wt %, or from 0.001 wt %, or 0.005 wt %, or 0.01 wt %, or 0.02 wt %, or 0.03 wt % to 0.05 wt %, or 0.1 wt %, or 0.2 wt %, or 0.5 wt %, or 1.0 wt %, or 3.0 wt %, or 5.0 wt %, or 10 wt % or 20 wt % moisture cure catalyst, based on the total weight of the composition. The moisture cure catalyst is typically added to the article manufacturing-extruder (such as during cable manufacture) so that it is present during the final melt extrusion process. As such, the silane functionalized polyolefin may experience some crosslinking before it leaves the extruder with the completion of the crosslinking after it has left the extruder, typically upon exposure to moisture (e.g., a sauna, hot water bath or a cooling bath) and/or the humidity present in the environment in which it is stored, transported or used.

The moisture cure catalyst may be included in a catalyst masterbatch blend with the catalyst masterbatch being included in the polymeric composition. Nonlimiting examples of suitable catalyst masterbatches include those sold under the trade name SI-LINK™ from The Dow Chemical Company, including SI-LINK™ DFDA-5481 Natural and SI-LINK™ AC DFDA-5488 NT. In an embodiment, the polymeric composition contains 0 wt %, or from 0.001 wt %, or 0.01 wt %, or 0.5 wt %, or 1.0 wt %, or 2.0 wt %, or 3.0 wt %, or 4.0 wt % to 5.0 wt %, or 6.0 wt %, or 7.0 wt %, or 8.0 wt %, or 9.0 wt %, or 10.0 wt %, or 15.0 wt %, or 20.0 wt % moisture cure catalyst masterbatch, based on total weight of the polymeric composition.

In an embodiment, the polymeric composition includes an ultraviolet (UV) absorber or stabilizer. A nonlimiting example of a suitable UV stabilizer is a hindered amine light stabilizer (HALS). A nonlimiting example of a suitable HALS is 1,3,5-triazine-2,4,6-triamine, N,N-1,2-ethanediylbisN-3-4,6-bisbutyl(1,2,2,6,6-pentamethyl-4-piperidinyl) amino-1,3,5-triazin-2-ylaminopropyl-N,N-dibutyl-N,N-bis(1,2,2,6,6-pentamethyl-4-piperidinyl)-1,5,8,12-tetrakis[4,6-bis (n-butyl-n-1,2,2,6,6-pentamethyl-4-piperidylamino)-1,3,5-triazin-2-yl]-1,5,8,12-tetraazadodecane, which is commercially available as SABO™ STAB UV-119 from SABO S.p.A. of Levate, Italy. In an embodiment, the composition contains 0 wt %, or from 0.001 wt %, or 0.002 wt %, or 0.005 wt %, or 0.006 wt % to 0.007 wt %, or 0.008 wt %, or 0.009 wt %, or 0.01 wt %, or 0.2 wt %, or 0.3 wt %, or 0.4 wt %, or 0.5 wt %, 1.0 wt %, or 2.0 wt %, or 2.5 wt %, or 3.0 wt % UV absorber or stabilizer, based on total weight of the polymeric composition.

In an embodiment, the polymeric composition includes a filler. Nonlimiting examples of suitable fillers include carbon black, organo-clay, aluminum trihydroxide, magnesium hydroxide, calcium carbonate, hydromagnesite, huntite, hydrotalcite, boehmite, magnesium carbonate, magnesium phosphate, calcium hydroxide, calcium sulfate, silica, silicone gum, talc and combinations thereof. The filler may or may not have flame retardant properties. In an embodiment, the filler is coated with a material that will prevent or retard any tendency that the filler might otherwise have to interfere with the silane cure reaction. Stearic acid is illustrative of such a filler coating. In an embodiment, the polymeric composition contains 0 wt %, or from 0.01 wt %, or 0.02 wt %, or 0.05 wt %, or 0.07 wt %, or 0.1 wt %, or 0.2 wt %, or 0.3 wt %, or 0.4 wt % to 0.5 wt %, or 0.6 wt %, or 0.7 wt %, or 0.8 wt %, or 1.0 wt %, or 2.0 wt %, or 2.5 wt %, or 3.0 wt %, or 5.0 wt %, or 8.0 wt %, or 10.0 wt %, or 20 wt % filler, based on total weight of the polymeric composition.

In an embodiment, the polymeric composition includes a processing aid. Nonlimiting examples of suitable processing aids include oils, polydimethylsiloxane, organic acids (such as stearic acid), and metal salts of organic acids (such as zinc stearate). In an embodiment, the polymeric composition contains 0 wt %, or from 0.01 wt %, or 0.02 wt %, or 0.05 wt %, or 0.07 wt %, or 0.1 wt %, or 0.2 wt %, or 0.3 wt %, or 0.4 wt % to 0.5 wt %, or 0.6 wt %, or 0.7 wt %, or 0.8 wt %, or 1.0 wt %, or 2.0 wt %, or 2.5 wt %, or 3.0 wt %, or 5.0 wt %, or 10.0 wt % processing aid, based on total weight of the polymeric composition.

In an embodiment, the polymeric composition contains 0 wt %, or from greater than 0 wt %, or 0.001 wt %, or 0.002 wt %, or 0.005 wt %, or 0.006 wt % to 0.007 wt %, or 0.008 wt %, or 0.009 wt %, or 0.01 wt %, or 0.2 wt %, or 0.3 wt %, or 0.4 wt %, or 0.5 wt %, or 1.0 wt %, or 2.0 wt %, or 2.5 wt %, or 3.0 wt %, or 4.0 wt %, or 5.0 wt % to 6.0 wt %, or 7.0 wt %, or 8.0 wt %, or 9.0 wt %, or 10.0 wt %, or 15.0 wt %, or 20.0 wt %, or 30 wt %, or 40 wt %, or 50 wt % additive, based on the total weight of the polymeric composition.

In an embodiment, the polymeric composition includes
(A) from 35 wt % to 55 wt %, or from 40 wt % to 50 wt % of an ethylene/silane copolymer;
(B) from 15 wt % to 35 wt %, or from 20 wt % to 30 wt % of a flame retardant that is a tetrabromophthalic anhydride diamine siloxane (TDS) with the structure of Formula (1) or with the structure of Formula (2);
(C) from 10 wt % to 20 wt %, or from 12 wt % to 18 wt % of a first flame retardant synergist that is antimony trioxide;
(D) from 1 wt % to 10 wt %, or from 2 wt % to 7 wt % of a second flame retardant synergist that is zinc oxide;
(E) from greater than 0 wt % to 7 wt %, or from 2 wt % to 6 wt % of a moisture cure catalyst;
(F) 0 wt %, or from greater than 0 wt % to 7 wt %, or from 2 wt % to 6 wt % of a second polyolefin that is an ethylene-based polymer; and
(G) 0 wt %, or from greater than 0 wt % to 0.5 wt %, or from 0.05 wt % to 0.4 wt % of an antioxidant;
wherein the aggregate of components (A)-(G) amount to 100 weight percent of the polymeric composition.

In an embodiment, the polymeric composition includes
(A) from 35 wt % to 55 wt %, or from 40 wt % to 50 wt % of an ethylene/silane copolymer;
(B) from 15 wt % to 35 wt %, or from 20 wt % to 30 wt % of a flame retardant that is a tetrabromophthalic anhydride diamine siloxane (TDS) with the structure of Formula (1), or with the structure of Formula (2);
(C) from 10 wt % to 20 wt %, or from 12 wt % to 18 wt % of a first flame retardant synergist that is antimony trioxide;
(D) from 1 wt % to 10 wt %, or from 2 wt % to 7 wt % of a second flame retardant synergist that is zinc oxide;
(E) 0 wt %, or from greater than 0 wt % to 7 wt %, or from 2 wt % to 6 wt % of a moisture cure catalyst;
(F) 0 wt %, or from greater than 0 wt % to 7 wt %, or from 2 wt % to 6 wt % of a second polyolefin that is an ethylene-based polymer;
(G) 0 wt %, or from greater than 0 wt % to 0.5 wt %, or from 0.05 wt % to 0.4 wt % of an antioxidant;
wherein the aggregate of components (A)-(G) amount to 100 weight percent of the polymeric composition.

### 4. Cable

The present disclosure provides a cable. In an embodiment, the cable includes (i) a conductor and (ii) a coating on the conductor. The coating includes the polymeric composition composed of (i) a silane-functionalized polyolefin and (ii) the tetrabromophthalic anhydride diamine siloxane (TDS) with the structure of Formula (1) or with the structure of Formula (2).

A “conductor,” as used herein, is one or more wire(s) or fiber(s) for conducting heat, light, and/or electricity. The conductor may be a single wire/fiber or a multi-wire/fiber and may be in strand form or in tubular form. Non-limiting examples of suitable conductors include metals such as silver, gold, copper, carbon, and aluminum. The conductor may also be optical fiber made from either glass or plastic.

A “cable,” as used herein, is at least one wire or optical fiber within a sheath, e.g., an insulation covering or a protective outer jacket. Typically, a cable is two or more wires or two or more optical fibers bound together, typically in a common insulation covering and/or protective jacket. The individual wires or fibers inside the sheath may be bare, covered or insulated. Combination cables may contain both electrical wires and optical fibers. The cable can be designed for low, medium, and/or high voltage applications. Alternating current cables can be prepared according to the present disclosure, which can be low voltage, medium voltage, high voltage, or extra-high voltage cables. Further, direct current cables can be prepared according to the present disclosure, which can include high or extra-high voltage cables. Insulated electrical conductors normally comprise a conductive core covered by an insulation layer. The conductive core can be solid or braided (for example, a bundle of threads). Some insulated electrical conductors may also contain one or more additional elements, such as a semiconductor layer (or layers) and/or a protective cover (for example, coiled wire, tape or sheath). Examples are coated metal wires and electrical cables, including those for use in low voltage (“LV”, >0 to <5 kilovolts (kV) electricity distribution/transmission applications), medium voltage (“MV”, 5 to <69 kV), high voltage (“HV”, 69 to 230 kV) and extra-high voltage (“EHV”, >230 kV). Power cable assessments can use AEIC/ICEA standards and/or IEC test methods.

The cable includes the conductor and a coating on the conductor. The coating includes the polymeric composition (as previously disclosed herein) composed of a silane-functionalized polyolefin, and a flame retardant that is a tetrabromophthalic anhydride diamine siloxane (TDS) with the structure of Formula (1)

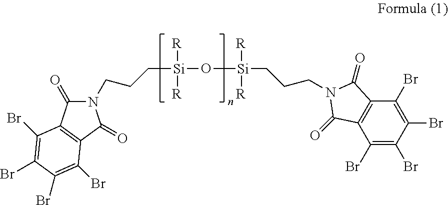

wherein n is an integer from 1 to 40, or from 2 to 30, or from 3 to 20, or from 4 to 15; and each R is the same or different and each R is independently selected from the group consisting of hydrogen, and a C₁-C₂₀ hydrocarbonyl group.

In an embodiment, the TDS has the structure of Formula (2).

The polymeric composition in the coating may include components (A)-(G) as previously disclosed herein.

In an embodiment, the cable includes a coating of the polymeric composition and the coating is a crosslinked insulation layer, the crosslinked insulation layer surrounding the conductor. In a further embodiment, the crosslinked insulation layer directly contacts the conductor. The term “directly contacts” refers to a layer configuration whereby the crosslinked insulation layer is located immediately adjacent to the conductor and no intervening layers or no intervening structures are present between the conductor and the crosslinked insulation layer. Alternatively, the crosslinked insulation layer indirectly contacts the conductor.

By way of example, and not limitation, some embodiments of the present disclosure will now be described in detail in the following Examples.

### EXAMPLES

Materials used in the comparative samples (CS) and in the inventive examples (IE) are provided in Table 1 below.

TABLE 1

| Material | Properties | Source |
|---|---|---|
| PE1 | d - 0.922 g/cc | Dow, Inc. |
| Ethylene silane copolymer | MI - 1.5 g/10 min | |
| MB1 | catalyst masterbatch containing a blend of 1- | Dow, Inc. |
| DBTDL catalyst master batch | butene/ethylene polymer, ethylene | |
| | homopolymer, phenolic compound antioxidant, | |
| | less than 5 wt % DBTDL (a moisture cure catalyst), | |
| | and a phenolic hydrazide compound | |
| Dowlex 2047 second polyolefin | d - 0.917 g/cc | Dow, Inc. |
| Linear low-density polyethylene | MI 2.3 g/10 min | |
| Flame retardant Saytex BT-93W Ethylene-bis-tetrabromophthalimide, Br content 67.2% 32588-76-4 | 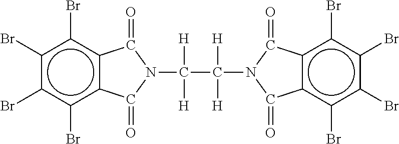 | Albemarle |
| Flame retardant Saytex HP 7010G Brominated polystyrene, Br content 68.5% 88497-56-7 | 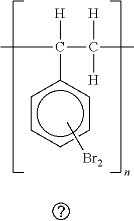 | Albemarle |
| TBPA Tetrabromophthalic Anhydride 632-79-1 | 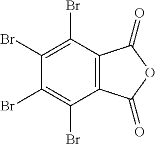 [SMILES: O=C1OC(=O)c2c(Br)c(Br)c(Br)c(Br)c21] | Sinopharm Chemical Reagent (SCRC) |
| BAPTMDS 1,3-Bis(3-aminopropyl)- 1,1,3,3-tetramethyldisiloxane SiSiB PC9410 (2469-55-8) | 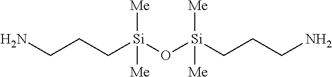 [SMILES: C[Si](C)(CCCN)O[Si](C)(C)CCCN] | Sinopharm Chemical Reagent (SCRC) |
| Flame retardant | Br content 57% | Dow Inc. |
| TDS Formula (2) | Mw - 1140 g/mol | |
| Antioxidant (AO) | Hindered phenol | BASF |
| Irganox 1010 | | |
| Flame retardant synergist | Zinc Oxide | Sinopharm Chemical |
| ZnO | | Reagent (SCRC) |
| Flame retardant synergist | Antimony trioxide | Yunnan Muli Antimony |
| Sb₂O₃ | Sb₂O₃ > 99.9% | |
| | Average particle size = 0.75 um | |

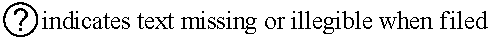

### 1. Synthesis of Tetrabromophthalic Anhydride Siloxane (TDS)

(30 mL) BAPTMDS (496 mg 2.0 mmol) was added to a solution of TBPA (1.94 g 4.2 mmol) in tetrahydrofuran (THF) solvent to form a reaction mixture. The reaction mixture was then refluxed for 4 hours (h). Later, the solvent (THF) was removed by a rotary evaporator and the residue was dissolved in chloroform (CHCl₃) and washed with warm water (60° C.) for five times. After the removal of chloroform, the off-white solid was dried in an oven at 80° C. overnight. TDS with the structure of Formula (2) Yield: 94%. ¹H NMR (400 MHz, CDCl₃, ppm): δ 3.67 (t, J=7.5 Hz, 2H), 1.73-1.65 (m, 2H), 0.54 (t, J=7.9 Hz, 2H), 0.05 (s, 2H), ¹³C NMR (100 MHz, CDCl₃, ppm): δ 163.9, 137.4, 130.8, 121.2, 41.9, 22.3, 15.4, 0.3. FT-IR (KBr, cm⁻¹): 2968, 2875, 1714, 1401, 1344, 1259, 669.

The reaction pathway for the synthesis of TDS with the structure of Formula (2) is shown in Reaction Scheme (1) below.

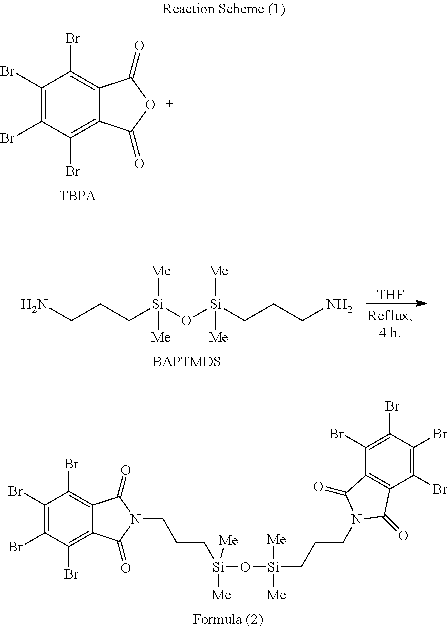 [SMILES: O=C1OC(=O)c2c(Br)c(Br)c(Br)c(Br)c21 ; C[Si](C)(CCCN)O[Si](C)(C)CCCN ; C[Si](C)(CCCN1C(=O)c2c(Br)c(Br)c(Br)c(Br)c2C1=O)O[Si](C)(C)CCCN1C(=O)c2c(Br)c(Br)c(Br)c(Br)c2C1=O ; "THF"]

### Flame Retardant TGA Analysis

TABLE 2

| Flame Retardant | Residue after test |
|---|---|
| Saytex BT-93W | 0% |
| Saytex HP-7010 | 0% |
| TDS Formula (2) | 5% |

As shown in Table 2, no char formed for Saytex BT-93 and Saytex HP-7010 while TDS with the structure of Formula (2) achieved 5% residue.

### 2. Preparation of Polymeric Composition

Ethylene/silane copolymer (PE1) and second polyolefin (Dowlex 2047, when present) are fed into a Brabender mixer set at a temperature of 160° C. and a rotor (Roller rotor) speed of 15 rotations per minute (rpm) for 3 minutes (min) to melt the polymer (and second polyolefin, when present). Antioxidant (AO), first/second flame retardant synergists (ZnO, Sb₂O₃), and flame retardant TDS with the structure of Formula (2) are fed into the mixer and subsequently the rotor rate is increased to 50 rpm and mixing continues for 5 minutes. The moisture cure catalyst master batch (DFDA-5481) is then added with mixing continued for another 1 minute. The polymeric composition is discharged from the Brabender mixer and formed into 2 millimeter (mm) thick plaques by compression molding at 125° C. The plaques are water bath cured at 90° C. for 8 hours.

Vertical burn test results for comparative samples (CS) and inventive examples (IE) are shown in Table 3 below.

TABLE 3
Polymeric compositions and vertical burn test results

| | CS1 | CS2 | IE1 | IE2 |
|---|---|---|---|---|
| PE1 | 45 | 45 | 45 | 45 |
| MB1 | 5 | 5 | 5 | 5 |
| Dowlex 2047 | 4.4 | 5 | 5 | |
| Saytex BT-93W | 25 | | | |
| Saytex HP 7010G | | 24.4 | | |
| TDS Formula (2) | | | 24.4 | 29.4 |
| Irganox 1010 (AO) | 0.1 | 0.1 | 0.1 | 0.1 |
| ZnO | 5 | 5 | 5 | 5 |
| Sb₂O₃ (FR synergist) | 15.5 | 15.5 | 15.5 | 15.5 |
| Total | 100 | 100 | 100 | 100.0 |
| Br Content, wt % | 16.8 | 16.7 | 13.8 | 16.6 |
| 1# - Flame time^{&} after the 1^{st} agitation/ | 1 s/36 s | Burn out* | 115 s/0 | 1 s/3 s |
| Flame time after the 2^{nd} agitation | | | | |
| 2# - Flame time^{&} after the 1^{st} agitation/ | 1 s/4 s | | 105 s/0 | 1 s/26 s |
| Flame time after the 2^{nd} agitation | | | | |
| 3# - Flame time^{&} after the 1^{st} agitation/ | | | | 2 s/35 s |
| Flame time after the 2^{nd} agitation | | | | |

*Burn out—the flame will not extinguish until specimen burns completely
^{&}Flame time is the time between fire removal and self-extinguishment of specimen

The Br content (in weight percent) in Table 3 was calculated based on the equation (A) below.

$$Equation ( A )$$

$$Br content = 79.9 * No . of Br in FR molecule * Percentage of FR in the composite / Mw of the FR$$

(a) Br content of Saytex BT-93W is 67.2 wt % according to product manual
(b) Br content Saytex HP 7010G is 68.5 wt % according to product manual
(c) Br content TDS Formula (2)=79.9*8/1131=56.5%
   79.9 is the Mw of Br
   8 is number of Br in one molecule of TDS Formula (2)
   1131 is the Mw of TDS Formula (2)
(d) The Br content for each of CS1, CS2, IE1, and IE2 is calculated by Wt. % of FR in each example*Br content of FR

$$( i ) CS 1 = 25 \% * 67.2 \% = 16.8 wt \%$$

$$( ii ) CS 2 = 24.4 \% * 68.5 \% = 16.7 wt \%$$

$$( iii ) IE 1 = 29.4 \% * 57.2 \% = 16.8 wt \%$$

$$( iv ) IE 2 = 29.4 \% * 56.5 \% = 16.8 wt \%$$

By way of example, in Table 3 the values “1 s/36 s” for CS1 run #1 “Flame time after the 1^{st} agitation/Flame time after the 2^{nd} agitation” indicate that the flame after the 1^{st} agitation self-extinguished within 1 second and the flame after 2^{nd} agitation self-extinguished within 36 seconds.

Comparative sample 1 (CS1) with flame retardant Saytex BT-93W (a small molecule brominated flame retardant with Mw 951.5 g/mol and CS2 with flame retardant Saytex HP 7010G (brominated polystyrene), were evaluated with inventive example 1 (IE1) and IE2, each containing the flame retardant TDS of Formula (2). As shown in Table 3, for CS1 the flame self-extinguished immediately after removing the flame in the first agitation. In the second agitation, CS1 self-extinguishes the flame in a short time. In CS1, Saytex BT-93W and known to be high in PBT characteristics. As a comparison, CS2 burned completely and did not self-extinguish in the first agitation. It is known that Saytex HP 7010G in CS2 has poor compatibility in polyethylene matrix.

IE1 (with flame retardant TDS of Formula (2)) has total lower Br content compared to CS2 (IE1 Br content 13.9 wt % compared to CS2 Br content 16.8 wt %). Even with lower Br content than CS2, IE1 self-extinguishes during the vertical flame test.

IE2 (with flame retardant TDS of Formula (2)) has a bromine content of 16.8 wt %, the same bromine content as CS1 and CS2. IE2, with the Br loading at the same level of CS1 and CS2, has the same flame retardance performance as CS1.

It is specifically intended that the present disclosure not be limited to the embodiments and illustrations contained herein, but include modified forms of those embodiments including portions of the embodiments and combination of elements of different embodiments as come within the scope of the following claims.

1. A tetrabromophthalic anhydride diamine siloxane (TDS) with the structure of Formula (1) 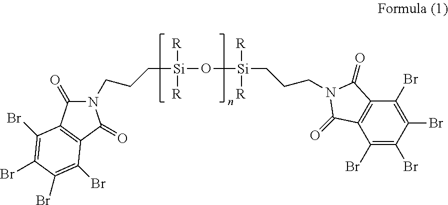
wherein n is an integer from 1 to 40; and
each R is the same or different and each R is independently selected from the group consisting of hydrogen, and a C₁-C₂₀ hydrocarbonyl group;

2. The TDS of claim 1 wherein the TDS with the structure of Formula (1) has a molecular weight from 1,000 g/mol to 5,000 g/mol.

3. The TDS of claim 1 wherein the TDS has the structure of Formula (2)

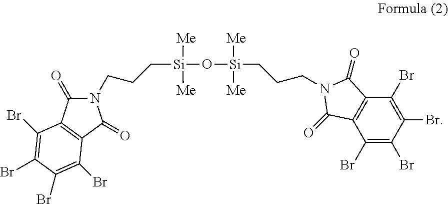 [SMILES: C[Si](C)(CCCN1C(=O)c2c(Br)c(Br)c(Br)c(Br)c2C1=O)O[Si](C)(C)CCCN1C(=O)c2c(Br)c(Br)c(Br)c(Br)c2C1=O]

4. A polymeric composition comprising:
a flame retardant that is a tetrabromophthalic anhydride diamine siloxane (TDS) with the structure of Formula (1) 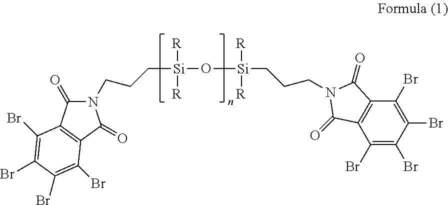
wherein n is an integer from 1 to 40; and
each R is the same or different and each R is independently selected from the group consisting of hydrogen, and a C₁-C₂₀ hydrocarbonyl group.

5. The polymeric composition of claim 4 comprising a silane-functionalized polyolefin.

6. The polymeric composition of claim 5 comprising
a silane-functionalized polyolefin that is an ethylene/silane copolymer;
the TDS with the structure of Formula (1); and
a flame retardant synergist.

7. The polymeric composition of claim 6 wherein the flame retardant synergist is selected from the group consisting of antimony trioxide, zinc oxide, and combinations thereof.

8. The polymeric composition of claim 5 comprising a second polyolefin.

9. The polymeric composition of claim 5 comprising a moisture cure catalyst.

10. The polymeric composition of claim 9 comprising
(A) from 35 wt % to 55 wt % of an ethylene/silane copolymer;
(B) from 15 wt % to 35 wt % of a flame retardant that is a TDS with the structure of Formula (1);
(C) from 10 wt % to 20 wt % of a first flame retardant synergist that is antimony trioxide;
(D) from 1 wt % to 10 wt % of a second flame retardant synergist that is zinc oxide;
(E) from greater than 0 wt % to 7 wt % of a moisture cure catalyst;
(F) greater than 0 wt % to 7 wt % of a second polyolefin that is an ethylene-based polymer; and
(G) from greater than 0 wt % to 0.5 wt % of an antioxidant;
wherein the aggregate of components (A)-(G) amount to 100 weight percent of the polymeric composition.

11. A cable comprising:
a conductor; and
a coating on the conductor, the coating comprising
a silane-functionalized polyolefin; and
a flame retardant that is a tetrabromophthalic anhydride diamine siloxane (TDS) with the structure of Formula (1) 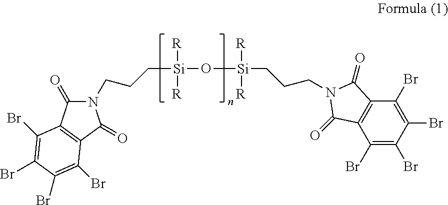
wherein n is an integer from 1 to 40; and
each R is the same or different and each R is independently selected from the group consisting of hydrogen, and a C₁-C₂₀ hydrocarbonyl group.
